(19) United States
(12) Patent Application Publication
(10) Pub. No.: US 2009/0001928 A1
(43) Pub. Date: Jan. 1, 2009

(54) Transformation of battery charger to power source using signature adapters

(76) Inventors: John Arthur Fee, Garland, TX (US); William S. Hart, Plano, TX (US); Gary Joseph Tole, Plano, TX (US); Robert Joseph Miles, Plano, TX (US)

Correspondence Address: JACKSON WALKER LLP, 901 MAIN STREET, SUITE 6000, DALLAS, TX, 75202-3797, US

(21) Appl. No.: 11/823,304

(22) Filed: Jun. 27, 2007

(51) Int. Cl. H02J 7/00

(52) U.S. Cl. 320/106

(57) ABSTRACT

A signature connector adapter adapted to provide additional capabilities for a battery charger beyond not only charge batteries, but performing other user-friendly functions is presented. One embodiment utilizes a resistor disposed within a signature charger adapter to detect battery type and communicate the battery type to the battery charger. The signature connector adapter provides information such as, but not limited to, battery chemistry, battery voltage, charging capabilities, and thermal limits. The battery charger can then optimize charging performance. The signature connector adapter allows a plurality of household, construction, medical and military devices to be charged and/or powered via the battery charger. Devices such as lights, radios, cigarette lighters, and other such devices requiring specific levels or types of power can now be operated and charged with a single charger, since the signature connector adapter facilitates the charging system changing its output to match the device's requirements.

### REFERENCE TO RELATED APPLICATIONS

This application is related to co-pending U.S. patent application Ser. No. 11/728,462, entitled “METHOD AND APPARATUS FOR A REMOTE BATTERY CHARGER WITH A SELF-CONTAINED POWER SOURCE”, filed Mar. 26, 2007, the contents of which are incorporated herein by reference for all purposes.

### FIELD OF THE INVENTION

The present invention is generally related to battery chargers, and more specifically to battery charger adapters.

### BACKGROUND OF THE INVENTION

Conventional battery chargers are most often designed for only one application—battery charging. These chargers are usually designed to charge batteries of one device (e.g. users have a cell phone charger, a laptop charger, an MP3 player charger, etc, which is dedicated for that device). This is not a problem per se' but limits the use of the device and the charger. Typically, the charger is used only when the user needs to recharge the battery and the remainder of the time, the charger sits on the shelf not being used.

Prior solutions to the problem are that some battery charger manufacturers, have provided a “universal charger” including adapters establishing the battery charger's supply voltage to the required voltage for a particular device (i.e. an adapter for a cell phone has a unique connector and voltage which is different from a laptop connector and voltage, etc). While this allows for the charger to charge different device batteries, it does not provide a means for operating different accessories or systems directly from the charging apparatus.

### SUMMARY OF THE INVENTION

The present invention achieves technical advantages as a signature connector adapter adapted to provide additional capability for the battery charger to not only charge batteries, but also perform other user-friendly functions not previously considered. The purpose of the signature connector adapter is to, among other things, identify the unique “personality” of each of the attached electrical devices to ensure proper powering of the device, communicating with the charger current source to apply or change a certain current or float voltage (within certain broad voltage limits), instruct the battery charger to apply charging parameters to a battery, and communicate unidirectionally or bidirectionally with a microprocessor or other device via the single or multi-line bus. The purpose of the signature connector adapter is not intended to precisely regulate voltage. The signature connector adapter provides information such as, but not limited to, battery type, battery chemistry, battery voltage, charging capabilities, and thermal limits. The battery charger, knowing this, can then optimize charging performance, while the signature connector adapter allows a plurality of household and construction devices to be charged and/or powered via the battery charger. The signature connector adapter optimizes the power transfer from the charger to the accessory device.

Additionally, the present invention is adapted to create a multi-vendor power tool charging system which can charge most batteries of most chemistries by using signature connector adapters which mate with the individual vendor battery and connect to the battery charger. Some embodiments utilize a radio receiver/amplifier disposed within the signature connector adapter to decode and play radio signals through a speaker or headphone system, or can utilize a light generating device disposed within the signature connector adapter to provide a light source which illuminates a given area around the charging system.

Devices disposed within the signature connector adapter, such as cigarette lighters, hand-helds, battery operated Doppler ultrasound, mobile carts, laser aiming & guidance, laptop computers, personal assistants, night-vision, global positioning systems, and other devices requiring specific levels or types of power, can now be operated and charged with a single battery charger, since the signature connector adapter facilitates the charging system to establish its output to match the device's requirements.

### BRIEF DESCRIPTION OF THE DRAWINGS

FIG. 1 is a diagram of an implementation of a signature connector adapter in accordance with an exemplary embodiment of the present invention;

FIG. 2 is a diagram of a method for determining the activity an electrical device is to perform in accordance with an exemplary embodiment of the present invention; and

FIG. 3 is a diagram of a method for altering a current signal waveform to allow enhanced operation of an electrical device in accordance with an exemplary embodiment of the present invention.

### DETAILED DESCRIPTION OF THE PRESENT INVENTION

A battery charger provides a current source which can supply controlled current to a plurality of devices which can use the battery charger as a charging device, or a power source for device operation. A battery charger is used with a plurality of OEM (Original Equipment Manufacturers) standardized connectors which allow “transformation” of a battery charger current source in order to attach useful devices for a user. This can be applied to most any device, such as a light which can be plugged into the battery charger, or a 12 VDC automotive style connector which can be plugged into the battery charger, or a host of other devices.

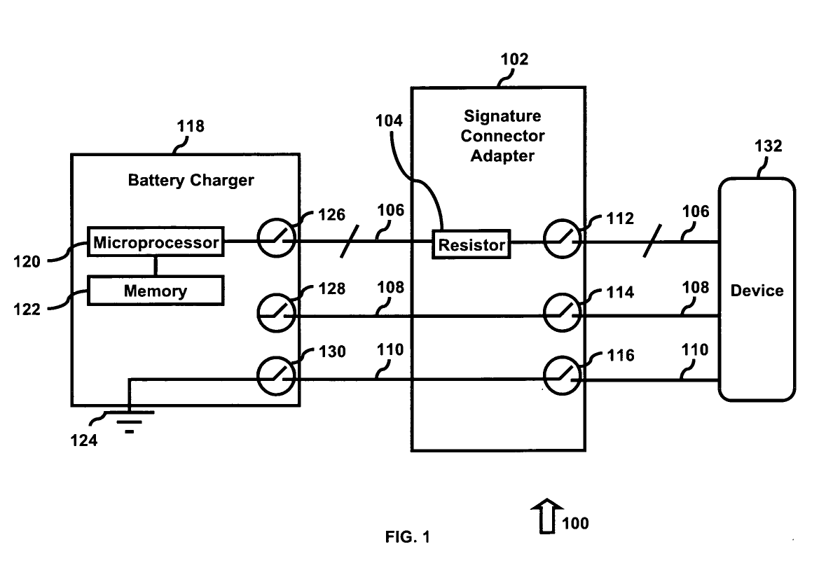

Referring to FIG. 1, there is shown at 100 a diagram of an implementation of a signature connector adapter 102 in accordance with an exemplary preferred embodiment of the present invention. Signature connector adapter 102 allows electronic device 132, which can have one of a plurality of different power interface connectors, to be electrically interfaced to and charged and/or powered by battery charger 118.

Signature connector adapter 102 is comprised of a housing made of non-conductive material, electrical component having a parameter, 104 such as a resistor, data line 106, power line 108, and ground line 110. The housing is adapted to operably and securely interface with battery charger 118 on one end and operably and securely interface with electronic device 132 on a second opposing end. Data line 106 is configured to be appropriately aligned to create an electrical connection, via contact 126, between component 104 of signature connector adapter 102 and microprocessor 120 of battery charger 118, thereby allowing electronic communication therethrough. Component 104 is disposed in series with data line 106. In one exemplary embodiment, resistor 104 is one of a myriad of possible electrical components including, but not limited to: a microprocessor with memory, an ASIC, a resistor/capacitor combination, a read only memory, or a random access memory. Data line 106 consists of 1 or more lines which can be configured to uniquely identify the pluggable device and can communicate either serially (1 line) or parallel (more than 1 line) and can also communicate in a unidirectional or bidirectional fashion. Data line 106, having a single line, can be configured with a simple resistor or other device including a single unidirectional or bidirectional microprocessor. Data line 106, having a plurality of lines, can communicate with a microprocessor or other device, in a uni- or bidirectional fashion, and can uniquely identify the attached pluggable device.

Power line 108 is appropriately aligned to create an electrical connection, via contact 128, between signature connector adapter 102 and battery charger 118, thereby providing power therethrough. Ground line 110 is appropriately aligned to create an electrical connection, via contact 130, between signature connector adapter 102 and ground 124 of battery charger 118, thereby providing electronic ground 124 therethrough.

Data line 106 is appropriately aligned to create an electrical connection, via contact 112, between signature connector adapter 102 and device 132, thereby allowing electronic communication therethrough. Power line 108 is appropriately aligned to create an electrical connection, via contact 114, between signature connector adapter 102 and device 132, thereby allowing power to propagate therethrough. Ground line 110 is appropriately aligned to create an electrical connection, via contact 116, between signature connector adapter 102 and ground 124 of battery charger 118, thereby allowing power to propagate therethrough.

In one exemplary embodiment, signature connector adapter 102 is operably and securely interfaced with battery charger 118. Device 132 is then operably and securely interfaced with signature connector adapter 102. The coupling of the three components allows availability of electrical ground, data, and power to propagate between battery charger 118 and device 132, through signature connector adapter 102, regardless of connector and/or battery type.

In a second exemplary embodiment, data line 106 propagates manufacturer information from device 132 to microprocessor 120 so that custom charging parameters may be provided to the device charging and/or powering in accordance with the respective manufacturer information. In a third exemplary embodiment, device 132 is any load (with or without battery) which may need power factor control and/or a modulated (or un-modulated) current-transformed electrical signal. Component 104 is disposed within signature connector adapter 102, and is in electronic communication with device 132 on one end and battery charger 118 on the other end.

When signature connector adapter 102 is coupled to battery charger 118, microprocessor 120 queries signature connector adapter 102 via data line 106 in order to identify the manufacturer of device 132. Microprocessor 120 correlates the manufacturer information of device 130 with a look-up table stored in memory 122 which is operably coupled to microprocessor 120. When a match is found in the look-up table for device 132, charging and/or powering parameters of a current source of the battery charger 118 are instantiated in microprocessor 120. Furthermore, the specific function for which signature connector adapter 102 is to be used is ascertained from the look-up table.

In a fourth exemplary embodiment, signature connector adapter 102 is adapted for battery charging. Charging parameters such as battery chemistry, OEM, and voltage are identified by the signature connector adapter, which component 104 may indicate. Then, microprocessor 120 identifies the entire power supplying process from initialization to termination of charge as a function of these parameters. If signature connector adapter 102 provides some other function, microprocessor 120 “reads” that function from adaptor 102 and performs the requisite action. Once microprocessor 120 has successfully determined the steps necessary to perform the function, it then applies the steps in microprocessor 120 to program a current source which provides a requisite charging/powering signal to device 132 through signature connector adapter 102.

In a fifth exemplary embodiment, device 132 is a lamp (i.e. light source) and is plugged into battery charger 118 in order to provide illumination for a work crew. When the user purchases device 132 with commensurate signature connector adapter 102 and plugs device 132 into battery charger 118, battery charger 118 recognizes that the attached device 132 is a lamp. There are at least two methods that battery charger 118 utilizes to recognize that device 132 is not a battery. One method is that signature connector adapter 102 contains a small chipset as component 104, which can communicate over the data bus 106 that triggers battery charger 118 into a certain charging state. Since battery charger 118 has logic which, for example, will terminate charging of a battery (and thereby shut off after a certain time or if a voltage is reached), battery charger 118 is forced into a state in which battery charger 118 “thinks” that a plurality of batteries are sequentially plugged into it (and thereby continues to charge) as long as the user needs device 132. The other option is for the charger to read the logic of adapter 102 and determine if it continually needs a regulated current source while allowing the voltage to float between Vmax and Vmin. Therefore, battery charger 118 “reads” the signature connector adapter 102 (one of the contacts is set to indicate that the charging signal stays ON for an indefinite period of time) and battery charger 118 continues to supply current to device 132 as long as illumination is needed.

In a sixth exemplary embodiment the system provides a method for providing one or more adapter connections housed in one adapter housing, wherein the adapter housing can accept multiple batteries inserted one at a time. This is achieved by housing multiple identities within the adapter housing which are triggered when the battery is inserted into a particular position in the adapter.

A second method for battery charger 118 to recognize that device 132 is not a battery is that signature connector adapter 102 can also contain memory and a capability to download software to microprocessor 120 of battery charger 118, thereby modifying battery charger 118 to provide constant current to device 132 while the voltage floats between rails (Vmax and Vmin). In the previous two methods, battery charger 118 does not need to have discrimination logic stored in memory 122.

A third, simpler method, is for microprocessor 120 of battery charger 118 to “read” a resistor which is installed in signature connector adapter 102 and, determining the value, it recognizes that device 132 is an illumination device. In order for microprocessor 120 of battery charger 118 to recognize device 132, the different possible values in association with device types must already be stored into memory 122. These are three methods of a myriad of methods for battery charger 118 to identify that device 132 is not a battery.

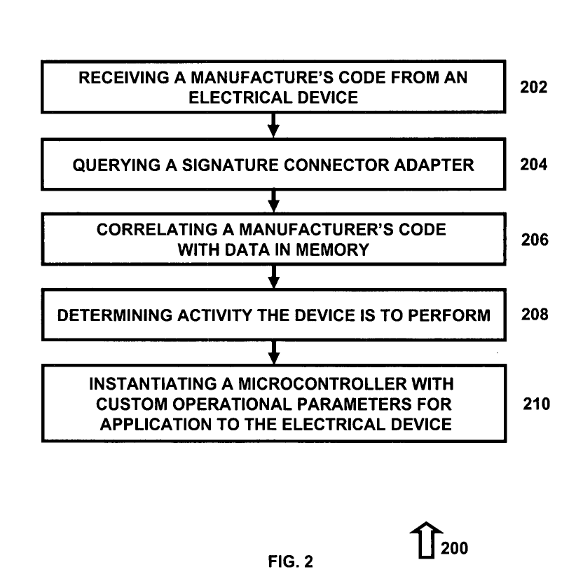

Referring to FIG. 2, there is shown at 200 a diagram of a method for determining the activity an electrical device is to perform in accordance with an exemplary embodiment of the present invention. The method begins at 202, where a manufacturer's code is received by signature connector adapter 102 from an attached device 132. In one exemplary embodiment, the device is a four bit word. In a second exemplary embodiment, the code is a voltage across resistor 104. In a third exemplary embodiment, the code is processed by a microprocessor disposed within signature connector adapter 102. In a fourth exemplary embodiment, the code is the voltage across a resistor/capacitor combination. In a fifth exemplary embodiment, the code is stored in a storage device disposed within signature connector adapter 102. The method then proceeds to 204.

At 204, microprocessor 120 of battery charger 118 queries signature connector adapter 102 in order to determine what device 132 is. In one exemplary embodiment, the microprocessor disposed within signature connector adapter 102 establishes communication with a microprocessor disposed within device 132. In a second exemplary embodiment, a voltage is supplied to resistor 104 disposed within signature connector adapter 102 and the voltage across resistor 132 is measured. The method then proceeds to 206.

At 206, the manufacturer's code is correlated with manufacturer data stored in a look-up table in memory 122 of battery charger 118. In one exemplary embodiment, the manufacturer's code is correlated with other manufacturer codes stored in memory 122. In a second exemplary embodiment, a voltage value measured across resistor 104 from a predetermined voltage is correlated with other voltage values measured across resistor 104 stored in memory 122. The method then proceeds to 208.

At 208, the function of the device is determined. In one exemplary example, the function of device 132 is determined by reading a function field in the look-up table in memory 122. The method then proceeds to 210.

At 210, microcontroller 120 is instantiated with custom parameters for charging and/or powering device 132. In one exemplary embodiment, the current generated by battery charger 118 is set to a specific value optimized for the specific device 132.

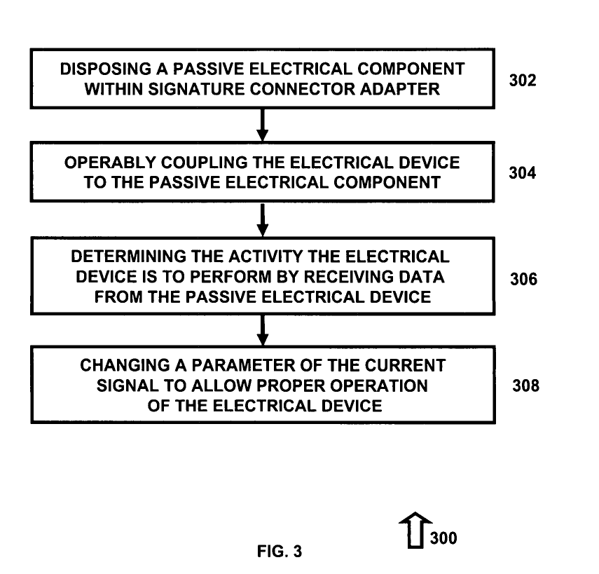

Referring to FIG. 3, there is shown at 300 a diagram of a method for altering a current signal waveform to allow enhanced operation of an electrical device in accordance with an exemplary embodiment of the present invention. The method begins at 302, where a passive electrical component is disposed within signature connector adapter 102. In one exemplary embodiment, the passive electrical component is an analogue circuit. The method then proceeds to 304.

At 304, the electrical device is operably and securely coupled to the passive electrical component. In one exemplary embodiment, a highly conductive metal contact establishes electronic communication between the electronic device and the passive electrical component. The method then proceeds to 306.

At 306, the activity the electrical device is to perform is determined by receiving data from the passive electrical component. In one exemplary embodiment, the data is a manufacturer's code. In a second exemplary embodiment, the data is propagated along a data line and/or lines. The method then proceeds to 308.

At 308, a parameter of the current signal waveform is changed to allow proper operation of the electrical device. In one exemplary embodiment, the frequency of the current signal waveform is changed to the resonant frequency of the electronic device. In a second exemplary embodiment, the frequency of the current signal waveform is changed to a harmonic of the resonant frequency of the device.

The present invention achieves technical advantages because the signature connector adapter allows a plurality of devices to be powered and/or charged by a single battery charger. This allows utilities beyond current uses for battery chargers. Additionally, other solutions do not use an intelligent signature connector adapter to both establish communication with the device and provide a means for operably and securely interfacing the device with the battery charger.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A method for determining the activity an electrical device is to perform, comprising:
receiving a code from the electrical device;
querying a signature connector adapter for the code;
correlating the code with data stored in a storage device;
determining the function of the device from the correlated code and data; and
instantiating a microcontroller with custom operational parameters for application to the electrical device based on the activity the device is to perform.

2. The method of claim 1, wherein the code specifies a manufacturer.

3. The method of claim 1, wherein the code specifies device type.

4. The method of claim 1, wherein the code specifies a function of the device.

5. The method of claim 1, wherein one of the operational parameters is a device charging algorithm.

6. The method of claim 1, wherein one of the operational parameters is a device powering algorithm.

7. The method of claim 1, wherein the storage device contains a manufacturer code.

8. The method of claim 1, wherein the storage device contains a device type code.

9. The method of claim 1, wherein the storage device contains a device function code

10. The method of claim 1, wherein the microcontroller is adapted to query the signature connector adapter for the code.

11. The method of claim 1, wherein the microcontroller is adapted to receive the code from the signature connector adapter.

12. The method of claim 1, wherein the microcontroller is adapted to correlate the received code with a stored code.

13. The method of claim 1, wherein the microcontroller is adapted to retrieve data associated with the device from the storage device.

14. A signature connector adapter, comprising:
a signature connector adapter housing adapted to operably and securely interface an electronic device on a first end and operably and securely interface a battery charger on a second end;
a device connector adapted to propagate a signal to and from the electronic device; and
a battery charger connector adapted to propagate a signal to and from the battery charger.

15. The signature connector adapter of claim 14, wherein the signature connector adapter housing is made of non-conductive material.

16. The signature connector adapter of claim 14, wherein the signature connector adapter housing is made of metal.

17. A method for altering a current signal waveform to allow enhanced operation of an electrical device, comprising:
disposing a passive electrical component within a signature connector adapter;
operably coupling the electrical device to the passive electrical component;
determining the activity the electrical device is to perform by receiving data from the passive electrical component; and
changing a parameter of the current signal waveform to allow proper operation of the electrical device.

18. The method of claim 17, further comprising: housing the passive component of the signature connector adapter in an adapter housing.

19. The method of claim 17, wherein the passive component is an analog circuit.

20. The method of claim 18, wherein the adapter housing can accept one or more batteries inserted one at a time.
